(19) United States
(12) Patent Application Publication
(10) Pub. No.: US 2011/0207006 A1
(43) Pub. Date: Aug. 25, 2011

(54) METHOD OF GENERATING HYDROGEN AND FUEL CELL USING THE METHOD

(75) Inventors: Hyun-chul LEE, Hwaseong-si (KR); Doo-hwan LEE, Suwon-si (KR); Sang-min JI, Suwon-si (KR)

(73) Assignee: SAMSUNG ELECTRONICS CO., LTD., Suwon-si (KR)

(21) Appl. No.: 13/029,740

(22) Filed: Feb. 17, 2011

(30) Foreign Application Priority Data
Feb. 18, 2010 (KR) 10-2010-0014727

(51) Int. Cl. H01M 8/06; C01B 3/12

(52) U.S. Cl. 429/420; 423/655; 423/656

(57) ABSTRACT

A method of generating hydrogen, the method including: reducing carbon dioxide to generate carbon monoxide and oxygen; separating the oxygen from the carbon monoxide; generating carbon dioxide and hydrogen by a water-gas shift reaction between water and the carbon monoxide remaining after the separating the oxygen from the carbon monoxide; and separating the generated carbon dioxide and hydrogen.

### CROSS-REFERENCE TO RELATED APPLICATIONS

This application claims priority to Korean Patent Application No. 10-2010-0014727, filed on Feb. 18, 2010, and all the benefits accruing therefrom under 35 U.S.C. § 119, the content of which in its entirety is herein incorporated by reference.

### BACKGROUND

1. Field

The present disclosure relates to a method of generating hydrogen and a fuel cell using the method.

2. Description of the Related Art

As one of the most plentiful natural resources on earth, hydrogen may be reacted with oxygen to generate energy, producing water as a by-product. Because use of hydrogen can displace use of other more limited resources, use of hydrogen may reduce exhaustion of the earth's limited natural resources and reduce environmental pollution. Also, hydrogen has high energy density per weight, and is easily converted into thermal and electrochemical energy. Accordingly, hydrogen is an alternative energy source which can prevent or reduce the exhaustion of earth's natural resources, global warming, and environmental pollution, which are in part due to the use of fossil fuels.

Hydrogen can be efficiently used in fuel cells, which use hydrogen as a fuel, and therefore much research into fuel cells using hydrogen has been conducted in accordance with energy industries and policies. However, there is much room for improvement in order to practically use fuel cells. In particular, fuel cells would preferably be provided a stable supply of hydrogen. Accordingly, there remains a need for an improved method of generating hydrogen.

### SUMMARY

Provided is a method of generating hydrogen for use as a fuel for a fuel cell.

Provided is a fuel cell using the method of generating hydrogen.

Additional aspects will be set forth in part in the description which follows and, in part, will be apparent from the description.

According to an aspect, disclosed is a method of generating hydrogen including: reducing carbon dioxide to generate carbon monoxide and oxygen; separating the oxygen from the carbon monoxide; generating carbon dioxide and hydrogen by a water-gas shift reaction between water and the carbon monoxide remaining after the separating the oxygen from the carbon monoxide; and separating the generated carbon dioxide and hydrogen.

According to another aspect, hydrogen and oxygen produced by the method are supplied to a fuel cell to constitute a fuel cell system.

Also disclosed is a fuel cell including: a fuel electrode, an air electrode, and an electrolyte membrane, wherein hydrogen and oxygen that are obtained by the method of generating hydrogen disclosed above are supplied to the fuel electrode and the air electrode, respectively; hydrogen is decomposed to form hydrogen ions and electrons in the fuel electrode, the hydrogen ions migrate to the air electrode via the electrolyte membrane, the electrons migrate to the air electrode via an external circuit while generating an electric current, and the hydrogen ions, the electrons, and the oxygen are combined to generate water in the air electrode.

### BRIEF DESCRIPTION OF THE DRAWINGS

These and/or other aspects will become apparent and more readily appreciated from the following description of the embodiments, taken in conjunction with the accompanying drawing in which:

FIG. 1 schematically shows an embodiment of a method of generating hydrogen provided to a fuel cell system.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be constructed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “a combination thereof” refers to a combination comprising at least one of the foregoing elements.

According to an embodiment of a method of generating hydrogen, hydrogen and oxygen may be prepared using carbon dioxide as a raw material. The hydrogen may be obtained by separating hydrogen obtained from a reaction between water and carbon monoxide. The carbon monoxide may be generated by photochemical conversion of carbon dioxide as a raw material, and oxygen generated with the carbon monoxide separated from the carbon monoxide. The hydrogen and oxygen thus obtained may be used in various processes or applications, including processes which use the hydrogen and/or oxygen as a raw material.

The method of generating hydrogen is conducted as shown in the reactions of Reaction Scheme 1.

### Reaction Scheme 1

CO₂→CO+½O₂=>oxygen separation

CO+H₂O→H₂+CO₂=>hydrogen separation

When hydrogen is combined with oxygen, electrons and energy (“Q”) are generated and may be provided to devices or processes which use the hydrogen and/or oxygen as a raw material as shown in Reaction Scheme 2. The hydrogen and oxygen may be separated as disclosed above.

### Reaction Scheme 2

H₂+½O₂->H₂O+e⁻+Q

The overall process is described in Reaction Scheme 3.

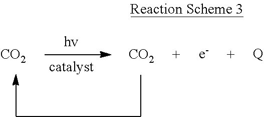

As further described above, water is generated by the reaction of intermediate products of hydrogen and oxygen and by using carbon dioxide (CO₂) as a raw material. Also, carbon dioxide is obtained as a final product. Because the raw material, i.e., carbon dioxide, is obtained as a final product, the carbon dioxide may be recycled. Also, because water (H₂O), which is used as a reactant, is generated as a product of the reaction of hydrogen and oxygen, water may also be recycled. The method of generating hydrogen will be disclosed in more detail.

Carbon dioxide, which is used as a raw material, is reduced to produce carbon monoxide and oxygen as shown in Reaction Scheme 4.

### Reaction Scheme 4

CO₂->CO+½O₂

The reaction may be conducted by irradiating light having a selected energy onto gaseous carbon dioxide in the presence of a photocatalyst. In this regard, any photocatalyst that is commonly used for the reduction of carbon dioxide by light irradiation may be used without limitation. Examples of the photocatalyst include a titania supported platinum (Pt), palladium (Pd), ruthenium (Ru), rhodium (Rh), or chromium (Cr), or a combination thereof; an oxide of tungsten (W), iron (Fe), titanium (Ti), zirconium (Zr), zinc (Zn), tantalum (Ta), niobium (Nb), vanadium (V), tin (Sn), lead (Pb), an alkali metal, or an alkali earth metal, or a combination thereof; a sulfide of zinc (Zn), gallium (Ga), indium (In), selenium (Se), or cadmium (Cd), or a combination thereof; a nitride of carbon (C), boron (B), gallium (Ga), germanium (Ge), or tantalum (Ta), or a combination thereof; a partially nitrided-oxide, a partially sulfided-oxide, or a partially carbonized-oxide of tungsten (W), iron (Fe), titanium (Ti), zirconium (Zr), zinc (Zn), tantalum (Ta), niobium (Nb), vanadium (V), tin (Sn), lead (Pb), an alkali metal, an alkali earth metal, gallium (Ga), or indium (In), or a combination thereof; or a combination thereof.

Oxygen is separated from the product of the reduction of carbon dioxide using an oxygen transfer membrane. The oxygen transfer membrane, specifically a membrane through which oxygen is selectively passed, may be an ion transfer membrane (“ITM”), a perovskite membrane, an yttria stabilized zirconia (“YSZ”) membrane, a Sc—ZrO₂ membrane, or the like, or a combination thereof. The separated oxygen may be used in a subsequent process.

After oxygen is separated from the product of the reduction of carbon dioxide, the residual carbon monoxide is used in a water-gas shift reaction with water to produce carbon dioxide and hydrogen as shown in the Reaction Scheme 5.

Reaction Scheme 5

CO+H₂O->H₂+CO₂

The water-gas shift reaction may be performed according to a method commonly used in the art, for example, in the presence of a catalyst suitable for the water-gas shift reaction. Any catalyst that is commonly used for the water-gas shift reaction may be used without limitation. For example, the catalyst for the water-gas shift reaction may be a Cu/ZnO/Al₂O₃ composite catalyst; a titania supported platinum (Pt), palladium (Pd), ruthenium (Ru), rhodium (Rh), chromium (Cr), or gold (Au), or a combination thereof; an oxide of supported tungsten (W), iron (Fe), titanium (Ti), zirconium (Zr), zinc (Zn), tantalum (Ta), niobium (Nb), vanadium (V), tin (Sn), lead (Pb), cerium (Ce), an alkali metal, or an alkali earth metal, or a combination thereof; or a combination thereof.

In an embodiment, carbon dioxide obtained from the water-gas shift reaction may be recycled as a raw material. Specifically, the carbon dioxide remaining after separating hydrogen from the product of the water-gas shift reaction may be supplied to the carbon dioxide reduction process as further described above, so that hydrogen is efficiently generated without discharging waste.

Then, hydrogen may be separated from the product obtained from the water-gas shift reaction using a hydrogen transfer membrane. The hydrogen transfer membrane may be any filter-shaped membrane. For example, the hydrogen transfer membrane may be a membrane comprising palladium (Pd), silica (SiO₂), copper (Cu), silver (Ag), or any alloy thereof, or a combination thereof.

According to an embodiment of the method of generating hydrogen, hydrogen and oxygen are separately obtained. The hydrogen and oxygen may be used in a variety of industrial applications, for example, in a fuel cell system using hydrogen as a fuel.

Fuel cells are devices that directly convert the chemical energy of fuel, such as hydrogen, liquefied natural gas (“LNG”), or liquefied petroleum gas (“LPG”) and air into electrical and thermal energy by an electrochemical reaction. Generally, a fuel cell includes a fuel electrode, an air electrode, and a membrane corresponding to an electrolyte layer. Hydrogen (H₂) is supplied to the fuel electrode and decomposed to provide a hydrogen ions (H⁺) and electrons (e⁻). The hydrogen ions migrate (e.g., transport) to the air electrode via the membrane, and the electrons migrate (e.g., transport) to the air electrode via an external circuit while generating an electric current. In the air electrode, the hydrogen ions, electrons, and oxygen combine to generate water. The chemical reactions in the fuel cell are represented in the reactions of Reaction Scheme 6.

### Reaction Scheme 6

Fuel electrode: H₂->2H⁺+2e⁻

Air electrode: ½O₂+2H⁺+2e⁻→H₂O

Entire reaction: H₂+½O₂→H₂

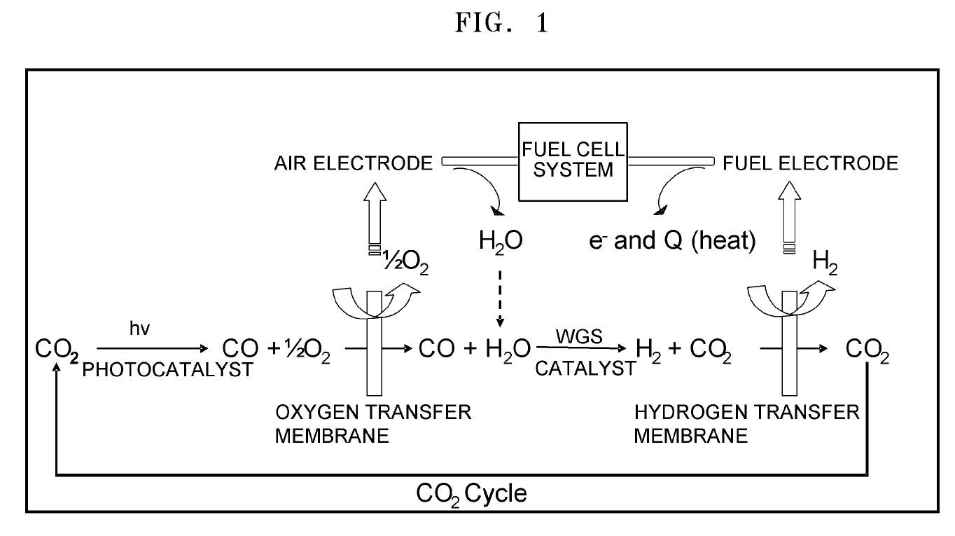

FIG. 1 schematically shows an embodiment of a method of generating hydrogen, which may be provided to a fuel cell system. As shown in FIG. 1, when light is irradiated onto carbon dioxide, which is a fuel, in the presence of a photocatalyst, the carbon dioxide is reduced to generate carbon monoxide and oxygen. The products are passed to an oxygen transfer membrane to separate oxygen therefrom. The separated oxygen is supplied to an air electrode of the fuel cell system. After oxygen is separated from the carbon monoxide, the residual carbon monoxide is contacted with water in the presence of a catalyst in a water-gas shift reaction to produce carbon dioxide and hydrogen. The products are passed to a hydrogen transfer membrane to separate hydrogen therefrom. The separated hydrogen is supplied to a fuel electrode of the fuel cell system. Hydrogen supplied to the fuel electrode of the fuel cell system is decomposed into hydrogen ions (H⁺) and electrons (e⁻). The hydrogen ions migrate (e.g., transport) to the air electrode via a membrane (e.g., an electrolyte layer) of the fuel cell system, and the electrons migrate to the air electrode via an external circuit while generating a current. Then, in the air electrode, oxygen is combined with hydrogen ions and electrons to generate water.

Each process shown in FIG. 1 is further described above. In the processes shown in FIG. 1, water that is obtained from the reaction between hydrogen and oxygen in the air electrode may be re-supplied to the water-gas shift reaction to be recycled, and carbon dioxide remaining after separating hydrogen therefrom using the hydrogen transfer membrane may be re-supplied as a fuel material, and thus may be recycled.

A fuel cell that uses hydrogen obtained according to the foregoing method as a fuel may be a phosphoric acid fuel cell, a molten carbonate fuel cell, a solid oxide fuel cell, or a polymer electrolyte membrane fuel cell, but is not limited thereto.

Carbon dioxide, oxygen, carbon monoxide, and hydrogen, which are used in the method of generating hydrogen, may be gases. Each process of the reaction is conducted at a suitable pressure and temperature, and the pressure and temperature may be varied by those of ordinary skill in the art without limitation.

The present invention will be described in further detail with reference to the following examples. These examples are for illustrative purposes only and are not intended to limit the scope of the present disclosure.

### EXAMPLE 1

CO₂ was converted into CO and O₂ using a lamp emitting light having wavelengths ranging from ultraviolet (“UV”) to a visible range (i.e., about 200 to about 700 nanometers, nm) or sunlight in the presence of a photocatalyst (a titania supported platinium).

O₂ was separated using an oxygen transfer membrane (YSZ membrane), and CO and water were subjected to a water-gas shift reaction in the presence of a catalyst (Cu/ZnO/Al₂O₃) to produce hydrogen and CO₂. The hydrogen was separated using a hydrogen transfer membrane (a membrane comprising palladium) to obtain hydrogen.

### EXAMPLE 2

The hydrogen and oxygen prepared according to Example 1 were respectively supplied to a fuel electrode and an air electrode of a polymer electrolyte membrane fuel cell (“PEMFC”) to generate electricity and heat. Water is discharged from the air electrode.

As described above, according to an embodiment, hydrogen and oxygen may be produced from carbon dioxide and water. The obtained hydrogen and oxygen may be applied to a variety of applications, such as a fuel cell.

It should be understood that the exemplary embodiments described herein should be considered in a descriptive sense only and not for purposes of limitation. Descriptions of features or aspects within each embodiment should be considered as available for other similar features or aspects in other embodiments.

What is claimed is:

1. A method of generating hydrogen, the method comprising:
reducing carbon dioxide to generate carbon monoxide and oxygen;
separating the oxygen from the carbon monoxide;
generating carbon dioxide and hydrogen by a water-gas shift reaction between water and the carbon monoxide remaining after the separating the oxygen from the carbon monoxide; and
separating the generated carbon dioxide and hydrogen.

2. The method of claim 1, wherein the reducing carbon dioxide further comprises irradiating light onto the carbon dioxide in the presence of a photocatalyst.

3. The method of claim 2, wherein the photocatalyst is
a titania supported platinum, palladium, ruthenium, rhodium, or chromium, or a combination thereof;
an oxide of tungsten, iron, titanium, zirconium, zinc, tantalum, niobium, vanadium, tin, lead, an alkali metal, or an alkali earth metal, or a combination thereof;
a sulfide of zinc, gallium, indium, selenium, or cadmium, or a combination thereof;
a nitride of carbon, boron, gallium, germanium, or tantalum, or a combination thereof;
a partially nitrided-oxide;
a partially sulfided-oxide; or
a partially carbonized-oxide of tungsten, iron, titanium, zirconium, zinc, tantalum, niobium, vanadium, tin, lead, an alkali metal, an alkali earth metal, gallium, or indium; or
a combination thereof.

4. The method of claim 1, wherein the separating the oxygen from the carbon monoxide further comprises selectively passing oxygen through an ion transfer membrane, a perovskite membrane, an yttria stabilized zirconia membrane, or a Sc—ZrO₂ membrane.

5. The method of claim 1, wherein the water-gas shift reaction is conducted in the presence of a catalyst, wherein the catalyst is
a Cu/ZnO/Al₂O₃ composite catalyst;
a titania supported platinum, palladium, ruthenium, rhodium, chromium, or gold, or a combination thereof;
an oxide of supported tungsten, iron, titanium, zirconium, zinc, tantalum, niobium, vanadium, tin, lead, cerium, an alkali metal, or an alkali earth metal, or a combination thereof; or
a combination thereof.

6. The method of claim 1, wherein carbon dioxide obtained by the water-gas shift reaction is reduced to generate carbon monoxide and oxygen.

7. The method of claim 1, wherein the separating the generated carbon dioxide and hydrogen further comprises separating with a hydrogen transfer membrane which comprises palladium, silica, copper, silver, or an alloy thereof, or a combination thereof.

8. A fuel cell comprising:
a fuel electrode,
an air electrode, and
an electrolyte membrane,
wherein hydrogen and oxygen that are obtained by the method of generating hydrogen according to claim 1 are supplied to the fuel electrode and the air electrode, respectively,
hydrogen is decomposed to form hydrogen ions and electrons in the fuel electrode,
the hydrogen ions migrate to the air electrode via the electrolyte membrane,
the electrons migrate to the air electrode via an external circuit while generating an electric current, and
the hydrogen ions, the electrons, and the oxygen are combined to generate water in the air electrode.

9. The fuel cell of claim 8, wherein the fuel cell is a phosphoric acid fuel cell, a molten carbonate fuel cell, a solid oxide fuel cell, or a polymer electrolyte membrane fuel cell.
